(19) United States
(12) Patent Application Publication
(10) Pub. No.: US 2008/0046483 A1
(43) Pub. Date: Feb. 21, 2008

(54) Method and system for selecting the timing of data backups based on dynamic factors

(76) Inventors: Douglas L. Lehr, Tucson, AZ (US); Franklin E. McCune, Tucson, AZ (US); David C. Reed, Tucson, AZ (US); Max D. Smith, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/464,856

(22) Filed: Aug. 16, 2006

(51) Int. Cl. G06F 17/30

(52) U.S. Cl. 707/204

(57) ABSTRACT

A system, method and computer program product for directing data backups with flexible timing of data backups based on the importance of the data and on the dynamic nature of the data content. Specifically, a Data Backup Timing (DBT) utility directs granular data backups by implementing the functions of monitoring data updates, revising data parameter values, and by conducting analyses using data parameter values. The DBT utility manages data back-up by automatically performing a back-up of data based on the following criteria: (1) the changes a data file undergoes; (2) whether a particular field has been modified; and (3) how critical the application data is as determined by the application owner. The DBT utility uses these criteria to provide a well timed data backup decision.

### BACKGROUND OF THE INVENTION

1. Technical Field

The present invention generally relates to data processing and in particular to backing up data within a data processing environment.

2. Description of the Related Art

Many businesses maintain data assets which periodically need to be backed up. In performing data backups, traditional methods and systems use commit points (backup points) which are fixed data backup schedules based on specific points in time used for general backing up of all data. These methods and systems with fixed data backup schedules have several limitations. For example, two limitations are that these methods and systems (1) require manual insertion of backup points and (2) have limited information about the volume of data changed, when directing a data backup to be executed.

All industries have various levels of “criticality”, which is a measure of the importance of a particular asset, such as the importance of a data asset. For example the banking industry's most critical data asset is customer account activity and balance. On the other hand, this industry has a large quantity of other customer data as well as administrative data which may not be as critical. Intuition suggests that critical data require more frequent backing up than less critical data. Additionally, data that changes frequently and/or data that undergo significant changes in its content need to be backed up more often than data which seldom changes. For example, highly critical data undergoing extensive changes in a particular day may be ideally protected with at least two data backups on that particular day. On the other hand, existing methodology of fixed and periodic (nightly) backups, based perhaps on a file change indicator, neither accounts for the importance of the data nor the extent or the type of changes the data undergoes. Instead, this one size fits all approach to data backups is fairly rigid and inflexible. Methodologies that fix the timing of data backups with such static approaches tend to inadequately protect data given the unpredictable nature of a disaster.

Considering from among a company's data assets the critical value of certain data relative to the value of other data, the present invention recognizes the importance of providing a system than directs or performs data backups based on the importance of the data and the extent and type of the changes in data content.

### SUMMARY OF THE INVENTION

Disclosed is a system, method and computer program product for directing data backups with flexible timing of data backups based on the importance of the data and on the dynamic nature of the data content. Specifically, a Data Backup Timing (DBT) utility directs granular data backups by implementing the functions of monitoring data updates, revising data parameter values, and by conducting analyses using data parameter values. In order to track data characteristics, the DBT utility enables a graphical user interface (GUI) to receive various user specified data parameter values. Among these user-specified values are data importance parameter values which signify the level of importance of data to a business. The DBT utility uses this data importance value to prioritize updates from an application or from changes in data content when determining the timing of data backups. In addition, the DBT utility receives (via GUI) a user-specified recovery point objective (RPO) and recovery time objective (RTO) for each class of data (or application). The DBT utility also receives user specified threshold values of data parameters that characterize the changes in data content. The data parameters which indicate changes in data content over time are hereinafter referred to as value changing parameters (VCPs). These VCPs may include one or more of the following: (a) number of bytes updated, (b) number of records modified, (c) number of I/O requests, (d) number of tracks modified, (e) actual files modified and (f) elapsed time since last backup.

Once the DBT utility has received the values of all user specified parameters, the DBT utility monitors the changes in data content and updates the VCP values. The DBT utility also compares the VCP values to their threshold values. Furthermore, the DBT utility determines the timing and the type of backup that takes place by factoring the following: (a) data importance parameter values; (b) RPO and RTO values; and (c) the crossing of VCP threshold values by VCP values. In one embodiment, the DBT utility has the ability to select a single criterion or multiple criteria on which to base the backup needs of any application or data. Once data backup takes place, the DBT utility resets the VCP values (of data being backed up) to a starting value.

In an alternate embodiment, data storage policies, which guide the data backup process to specific storage locations and storage media, are also received by the DBT utility via GUI.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a data processing system within which the features of an illustrative embodiment may be advantageously implemented;

FIG. 2 is block diagram of an example set of banking data records with corresponding parameter values, according to the described embodiment; and

FIG. 3 is a flowchart depicting the process steps enabled by executing the data backup timing (DBT) utility, according to an illustrative embodiment.

### DETAILED DESCRIPTION OF AN ILLUSTRATIVE EMBODIMENT

Disclosed is a system, method and computer program product for directing data backups with flexible timing of data backups based on the importance of the data and on the dynamic nature of the data content. Specifically, a Data Backup Timing (DBT) utility directs granular data backups by implementing the functions of monitoring data updates, revising data parameter values, and by conducting analyses using data parameter values. In order to track data characteristics, the DBT utility enables a graphical user interface (GUI) to receive various user specified data parameter values. Among these user-specified values are data importance parameter values which signify the level of importance of data to a business. The DBT utility uses this data importance value to prioritize updates from an application or from changes in data content when determining the timing of data backups. In addition, the DBT utility receives (via GUI) a user-specified recovery point objective (RPO) and recovery time objective (RTO) for each class of data (or application). The DBT utility also receives user specified threshold values of data parameters that characterize the changes in data content. These value changing parameters (VCPs) which indicate changes in data content over time may include one or more of the following: (a) number of bytes updated; (b) number of records modified; (c) number of I/O requests; (d) number of tracks modified; (e) actual files modified; and (f) elapsed time since last backup.

Once the DBT utility has received the values of all user specified parameters, the DBT utility monitors the changes in data content and updates the VCP values. The DBT utility also compares the VCP values to their threshold values. Furthermore, the DBT utility determines the timing and the type of backup that takes place by factoring the following: (a) data importance parameter values; (b) RPO and RTO values; and (c) the crossing of VCP threshold values by VCP values. In one embodiment, the DBT utility has the ability to select a single criterion or multiple criteria on which to base the backup needs of any application or data. Once data backup takes place, the DBT utility resets the VCP values (of data being backed up) to a starting value.

In an alternate embodiment, data storage policies, which guide the data backup process to specific storage locations and storage media, are also received by the DBT utility via GUI.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is also understood that the use of specific parameter names are for example only and not meant to imply any limitations on the invention. The invention may thus be implemented with different nomenclature/terminology utilized to describe all parameters and/or associated features that are provided herein, without limitation.

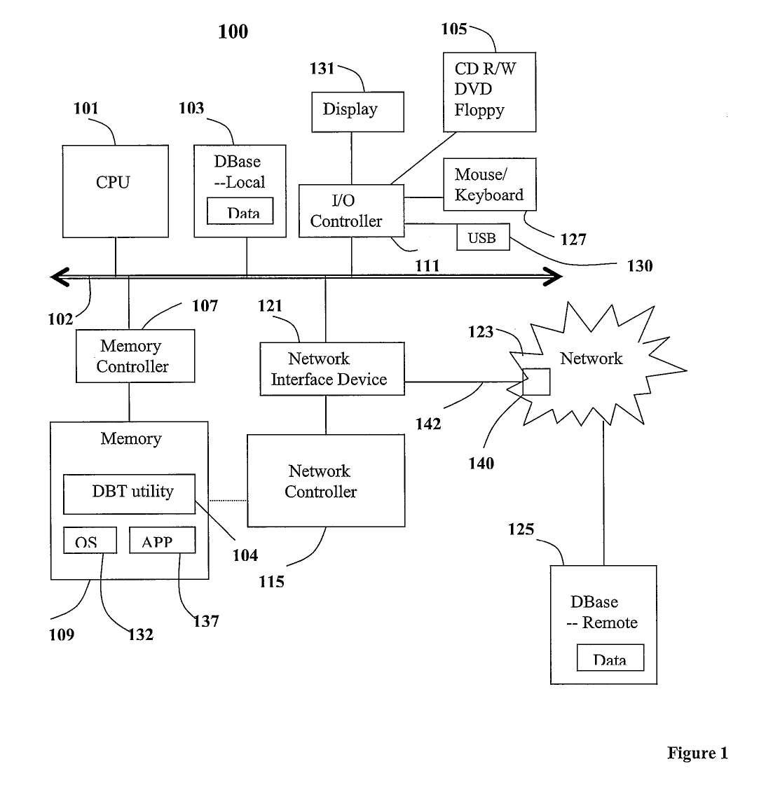

With reference now to the figures, FIG. 1 depicts a data processing system within which features of the invention may be advantageously implemented. Data processing system (DPS) 100 comprises central processing unit (CPU) 101 coupled to system bus/interconnect 102. Also coupled to system bus/interconnect 102, is memory controller 107, which controls access to memory 109. Database 103 is also coupled to system bus/interconnect 102. System bus 102 is coupled to input/output controller (I/O Controller) 111, which controls access to/from several input devices, of which mouse 126 and keyboard 127 are illustrated. I/O Controller 111 also controls access to output devices, of which display 131 is illustrated. In order to support use of removable storage media, I/O Controller 111 may further support one or more USB ports 130, and one or more drives 105 such as compact disk Read/Write (CDRW), digital video disk (DVD), and Floppy disk, for example.

DPS 100 further comprises network interface device (NID) 121 by which DPS 100 is able to connect to and communicate with an external device or network 123 (such as the Internet) via wired or wireless connection 142. NID 121 may be a modem or network adapter and may also be a wireless transceiver device. DPS 100 is able to connect to and communicate with remote database 125 via Network 123.

Those of ordinary skill in the art will appreciate that the hardware depicted in FIG. 1 may vary. For example, other peripheral devices, such as optical disk drives and the like, also may be used in addition to or in place of the hardware depicted. Thus, the depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

Various features of the invention are provided as software code stored within memory 109 or other storage and executed by CPU 101. Among the software code are code for providing an operating system (OS), code for enabling network connection and communication via NID 121, and more specific to the invention, code for enabling Data Backup Timing (DBT) features described below. For simplicity, the collective body of code that enables DBT features is referred to herein as the DBT utility.

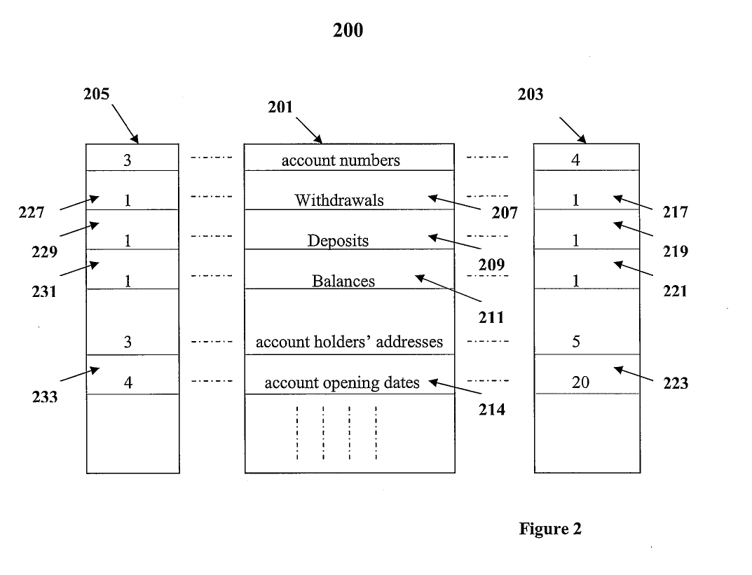

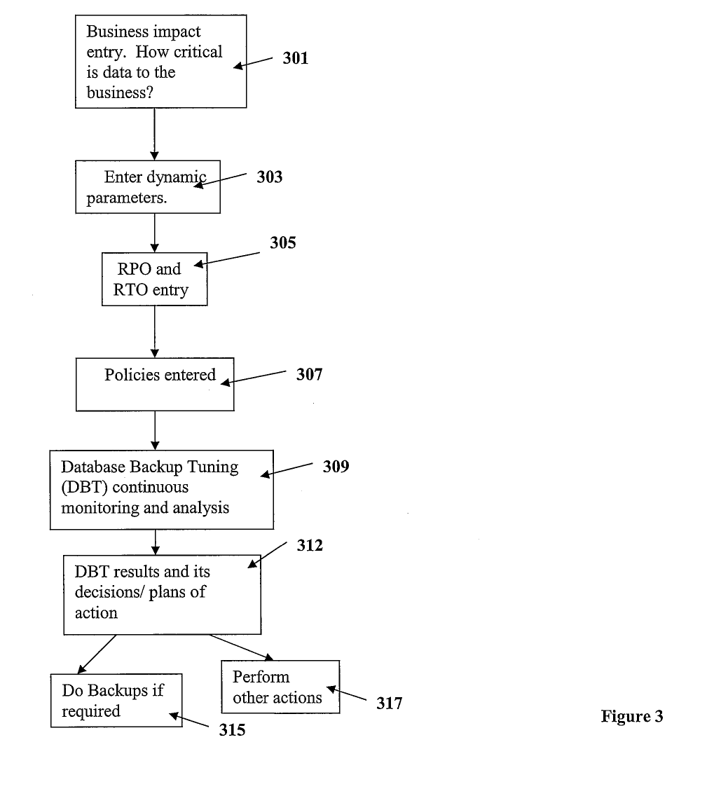

Thus, as shown by FIG. 1, in addition to the above described hardware components, data processing system 100 further comprises software components, including OS 132 (e.g., Microsoft Windows®, a trademark of Microsoft Corp, or GNU®/Linux®, registered trademarks of the Free Software Foundation and The Linux Mark Institute) and one or more software applications, including DBT utility 104. In implementation, software code of OS 132 and DBT utility 104 are executed by CPU 101. According to the illustrative embodiment, when processor 104 executes DBT utility 104, DBT utility 104 enables data processing system 100 to complete a series of functional processes, including: (1) providing an interface for user input of data parameter values and threshold values; (2) monitoring data for changes to the data content; (3) updating data parameters that correspond to the specific changes in data content; (4) performing analyses, which includes a comparison of VCP values to thresholds, to determine if a data backup is currently required; and (5) directing or initiating data backups based on the results of analyses; and other features/functionality described below and illustrated by FIGS. 2 and 3.

In the described embodiment, Data Backup Timing (DBT) utility 104 provides a graphical user interface (GUI), shown via display 131, in order to receive user specified parameters that are utilized in carrying out the functions of DBT utility 104. The administrator enters these parameters via GUI using input devices (e.g. mouse 126 and keypad 127). One of the key parameters utilized by DBT utility 104 is a data value (or importance) parameter. The data importance parameter is a measure of the critical importance a particular data or application is to a business. With the invention, strategies used to protect data from loss due to a disaster reflect the priorities assigned to data. DBT utility 104 is designed with functionality such that, in general, data which is more critical is backed up more frequently. This data importance parameter allows DBT utility 104 to set priorities of VCP value updates based on the significance given to changes in certain data. By assigning various data importance parameter values, DBT utility 104 is able to create a hierarchy of data priorities at the application, system, or user level, which accounts for a greater significance given to certain updates. For example, if an update comes in from a test system, the data may not require a backup to be made as quickly as if the update comes in from a production system. The DBT utility affords various applications that update different portions of a data set the option to provide unique backup criteria and backup methods for data within the data set. DBT utility 104 finely tunes to the specific and unique attributes of individual data within a larger data set.

Other parameters which form part of the criteria for the timing of data backups are the parameters which measure data content changes. These value changing parameters (VCPs) indicate how data changes over time and may include one or more of the following: (a) number of bytes updated; (b) number of records modified; (c) number of I/O requests; (d) number of tracks modified; (e) actual files modified; and (f) elapsed time since last backup. Through the GUI enabled by DBT utility 104, an administrator establishes thresholds for these VCPs.

In one embodiment, DBT utility 104 may set default values of VCP threshold values once data importance parameters are established. In an alternate embodiment, these VCP threshold default values may be modified via GUI.

Two other parameters, associated with each class of data or application and utilized by DBT utility 104 in its backup timing criteria, are recovery point objective (RPO) and recovery time objective (RTO). These two parameters (metrics) measure a business system's ability to tolerate lost data and downtime. The most critical issue facing data backup and recovery today is recovery time, and any down time may cost a business millions of dollars. The RTO indicates how much time the IT staff may be allotted in order to bring application 137 back online after a disaster occurs. The RPO denotes the amount of data an organization may afford to lose before the organization begins to suffer. Both RPO and RTO are measured in time, with values ranging from seconds to days or weeks. Lower RPO and RTO values for a particular application indicate a higher priority (which affects the timing and the frequency of data backups) when recovering the application systems after a disaster. These (RPO and RTO) parameter values are also received via GUI.

In one embodiment, DBT utility 104 uses data storage policies to guide the data backup process in choosing storage location and storage media. Storage media may include one of more of the media supported by drive 105. In addition, other media not specifically mentioned herein may be used for particular data storage. DBT utility 104 may direct a data backup to local or remote storage. Data storage policies may also be used by DBT utility 104 to trigger a backup program once backup is required. In addition, DBT utility 104 is able to assign data storage policies to allow an administrator to select any particular backup program from a set of data backup programs for data backup of any specific file/data set. Having backup program options allows the data/file set to have the backup program that performs the most efficient backup for the data/file type being backed up. DBT utility 104 allows the backup program to be assigned at the individual data set level and DBT utility 104 allows the administrator to select a different backup program for each data set if needed. DBT utility 104 also allows data backups to be completed as Full Volume Dumps, File Level Backups and Record Level Backups, depending on the extent and type of data backup required as determined by DBT utility 104.

According to the described embodiment, DBT utility 104 monitors the changes in data content and updates the values of the VCPs. These VCPs are automatically compared with their threshold values. In order to determine when a data backup takes place, DBT utility 104 factors the following: (a) the crossing of VCP thresholds by corresponding VCP values, taking into consideration the quantity and quality of thresholds crossed; (b) RPO and RTO values; and (c) data importance parameter values. DBT utility 104 is also able to select a single criterion (or parameter) or multiple criteria on which to base the backup needs of any application or data. DBT utility 104 immediately resets the values of the dynamic parameters (of data being backed up) to a starting value.

FIG. 2 depicts an example set of banking data records which illustrates parameters used by DBT utility 104 in carrying out the functions of DBT utility 104, according to the described embodiment. Specifically, FIG. 2 shows banking records 201 with associated data importance parameter 205 and RTO parameter 203. Certain records, withdrawals 207, deposits 209 and balances 211, have corresponding data importance indices 227, 229 and 231, respectively. In this example, the data importance index has a range of 1 (most critical) to 4 (less critical). These records (207, 209, and 211) have a data importance index of “1” and an RTO parameter value of “1” (minute) which indicates that they are all critically important. Conversely, account opening dates 214 have corresponding data importance index 233 of “4” and RTO value of “20” (minutes). Records such as account opening dates 214, which never change, are considered less critical. These parameter values, in addition to the VCP values, are used by DBT utility 104 to make sound decisions concerning data/database backups.

FIGS. 3a and 3b are flow charts illustrating the process steps enabled by the execution of DBT utility 104. The process begins at block 301, at which DBT utility 104 provides a graphical user interface (GUI) for allowing the entry of data parameter values by an administrator. At block 302, DBT utility 104 receives parameter values which measure the data's critical importance. This data importance parameter allows DBT utility 104 to set priorities of VCP value updates based on the significance given to certain data changes. By assigning various data importance parameter values, DBT utility 104 is able to create a hierarchy of data priorities at the application, system, or user level, which accounts for a greater significance given to certain updates. For example, if an update comes in from a test system, the data may not require a backup to be made as quickly as if the update comes in from a production system. The DBT utility affords various applications that update different portions of a data set the option to provide unique backup criteria and backup methods for data within the data set. DBT utility 104 finely tunes to the specific and unique attributes of individual data within a larger data set.

Returning to FIG. 3a, the process continues at block 303 at which DBT utility 104 receives the data storage policies. At block 305, the recovery point objective (RPO) and recovery time objective (RTO) parameters for each class of data are entered and recorded by DBT utility 104. The VCP threshold values are also entered by the administrator, as shown at block 306. The utilization of these VCP values by DBT utility 104 ultimately accounts for the particularly flexible timing of data backups. At block 307, DBT utility 104 begins processing with the received parameter values.

Turning now to FIG. 3b, at block 308, DBT utility 104 commences the monitoring, and updating functions, utilizing the received data parameters (FIG. 3a). As shown at block 309, DBT utility 104 continuously monitors data changes, and when such changes are detected, DBT utility 104 automatically updates the VCP values. The process continues at block 310, at which DBT utility 104 compares the current VCP values with their threshold values. DBT utility 104 determines, at block 312, if any thresholds have been crossed. When no thresholds have been crossed, DBT utility 104 continues to monitor data changes and update the VCP values, as block 309 indicates. As shown at block 315, when analyses by DBT utility 104 indicate thresholds have been crossed, DBT utility 104 decides if a data backup is required and the extent and type of the data backup. DBT utility 104 performs this determination by factoring the following: (a) the crossing of VCP thresholds taking into consideration the quality and quantity of thresholds crossed; (b) RPO and RTO values and; (c) data importance parameter values.

As shown at block 317, when DBT utility 104 determines that a data backup is currently required, DBT utility 104 initiates data backup, guided by pre-established data storage policies. At block 319, once data backup begins, DBT utility 104 resets the values of the dynamic parameters (of data being backed up) to a starting value. In an alternate embodiment, DBT utility 104 and the backup program may be packaged together such that the backup program becomes part of DBT utility 104. In such an embodiment, DBT utility 104 also performs the data backups.

In the flow charts (FIGS. 3a, 3b) above, while the process steps are described and illustrated in a particular sequence, use of the specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

The Data Backup Timing utility factors the importance of data and the dynamic nature of the data content in order to determine the timing and method by which data backups take place. The DBT utility allows business-critical data assets to be efficiently backed up and quickly recovered. In addition, the DBT utility proactively lessens the severity of potential outages while providing timely data backups. Ultimately, the DBT utility provides sound protection for the data assets of a business while contributing to the business' longevity.

As provided within the claims, the invention provides a method that completes the following: monitoring changes occurring to individual data within data set; analyzing each of the changes against a plurality of pre-established back-up criteria that collectively determine when a data backup should occur; and when the pre-established backup criteria for performing an backup on one of the individual data is met, dynamically triggering the back-up of that one individual data. The back-up is performed independent of the other individual data whose back-up criteria are not met, and thus an automatic granular back-up of each individual data is provided, based on the current changes to that individual data in the data set. To enable the above functions, the method further involves: linking a plurality of parameters, including a data importance parameter to each of the individual data, which is utilized as one criterion to prioritize updates from an application or from changes in data content when determining a time at which to trigger a data backup. Thus, in one embodiment, the data importance value correlates to a frequency at which the particular individual data is backed-up.

Further, the method provides: enabling user input of new values corresponding to the plurality of parameters for each individual data including a time frequency for performing granular back-ups within the data set using a back-up timer parameter. When the time frequency is not provided by the user, a default time frequency is established, correlated to the data importance value linked to each individual data, and the time frequency establishes frequency at which data assigned the particular data importance value is automatically backed-up to the data storage mechanism.

In one embodiment, the method further provides: automatically selecting a first storage facility among multiple available storage facilities for frequent short term back-up of data tagged with a highest data importance value; and subsequently enabling data tagged with the highest data importance value to be transferred to a more permanent storage facility, where the transfer is completed at a second, longer frequency than the short term back-up. Also, in another embodiment, the method enables automatic assignment of a selected one of the storage facilities to the individual data being backed up based on the analysis of the criteria which triggers the back-up of the individual data.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, DVDs, and thumb drives (ssee above), and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a data processing system having associated therewith one or more storage utilized to maintain a data set containing a plurality of individually-modifiable data (individual data), a method comprising:
monitoring changes occurring to individual data within data set;
analyzing each of said changes against a plurality of pre-established back-up criteria that collectively determine when a data backup should occur; and
when the pre-established backup criteria for performing an backup on one of said individual data is met, dynamically triggering the back-up of that one individual data, wherein said back-up is performed independent of the other individual data whose back-up criteria are not met, wherein an automatic granular back-up of each individual data is provided, based on the current changes to that individual data in the data set.

2. The method of claim 1, further comprising:
linking a plurality of parameters, including a data importance parameter to each of said individual data;
assigning a data importance value to each of said individual data, wherein said data importance value indicates a relative value and importance of the individual data to an owner of the data set, and wherein said data importance value is utilized as one criterion to prioritize updates from an application or from changes in data content when determining a time at which to trigger a data backup, such that said data importance value correlates to a frequency at which the particular individual data is backed-up;
performing said analyzing utilizing at least said data importance value to determine when to trigger the backup of the associated, individual data.

3. The method of claim 2, further comprising:
enabling user input of new values corresponding to the plurality of parameters for each individual data via a graphical user interface, said new values including at least the data importance value;
when said new values are not inputted, providing default values for each of said plurality of parameters; and
enabling user selection of a time frequency for performing granular back-ups within the data set using a back-up timer parameter;
wherein when said time frequency is not provided, a default time frequency is established, correlated to the data importance value linked to each individual data, wherein said time frequency establishes a time period at which data assigned the particular data importance value is automatically backed-up to the data storage mechanism.

4. The method of claim 2, wherein:
said plurality of parameters include:
one or more of a recovery point objective (RPO) and recovery time objective (RTO) for each class of data and application; and
one or more value changing parameters (VCPs), which indicate changes in data content over time, said VCPs including one or more of: (a) number of bytes updated; (b) number of records modified; (c) number of I/O requests; (d) number of tracks modified; (e) actual files modified; and (f) elapsed time since last backup; and
one or more threshold values corresponding to specific ones of data parameters that characterize changes in data content.

5. The method of claim 4, wherein:
said monitoring comprising:
monitoring changes in data content of the individual data; and
updating VCP values of the corresponding individual data based on said changes.
said analyzing further comprising:
comparing a value of each of said one or more VCPs against a corresponding threshold value;
considering additional criteria from among: a type of data change, a source of said data changes, and established back-up triggering conditions associated with the individual data and the data set; and
said dynamically triggering further comprising:
triggering said dynamic back-up based on at least one of said VCPs reaching its threshold value; and
automatically resetting the values of the VCPs of the individual data that is backed-up to a staring value following the backup.

6. The method of claim 5, further comprising:
determining a type of backup to perform for the individual data by factoring a plurality of the criteria from among: (a) data importance parameter value; (b) RPO and RTO values; and (c) the crossing of preset threshold values by updates to corresponding VCP values; and
determining, based on said criteria and the extent and type of data backup required, a level of backup to perform from among: Full Volume Dumps, File Level Backups and Record Level Backups.

7. The method of claim 2, wherein said data storage mechanism comprises multiple available storage locations and media, said method further comprising:
enabling selection of specific data storage policies assigned to the individual data within the data set, wherein said data storage policies guide a data backup of the individual data to be performed on specific storage locations and storage media;
wherein said dynamically triggering directs the specific storage location and storage media to which said data back-up is performed.

8. The method of claim 1, wherein:
said dynamically triggering said backup comprises signaling a separate data backup program to perform the backup of the specific individual data; and
when multiple backup programs are available to perform the backup, said method further comprises:
enabling a directed association between each of the individual data and specific one(s) of the multiple backup programs, such that said signaling provides a signal to the specific backup program associated with the individual data to perform the backup.

9. The method of claim 1, further comprising:
automatically selecting a first storage facility among multiple available storage facilities for frequent short term back-up of data tagged with a highest data importance value; and
subsequently enabling said data tagged with the highest data importance value to be transferred to a more permanent storage facility, wherein said transfer is completed at a second, longer frequency than the short term back-up.

10. The method of claim 1, wherein said plurality of storage facilities comprises one or more storage locations from among a remote database, a local database, and one or more removable storage media, said method further comprises:
automatically assigning a selected one of the storage facilities to the individual data being backed up based on the analysis of the criteria which triggers the back-up of the individual data.

11. A computer program product comprising:
a computer readable medium; and
program codes on the computer readable medium that when executed by a processor performs the functions of:
monitoring changes occurring to individual data within data set;
analyzing each of said changes against a plurality of pre-established back-up criteria that collectively determine when a data backup should occur; and
when the pre-established backup criteria for performing a backup on one of said individual data is met, dynamically triggering the back-up of that one individual data, wherein said back-up is performed independent of the other individual data whose back-up criteria are not met, wherein an automatic granular back-up of each individual data is provided, based on the current changes to that individual data in the data set.

12. The computer program product of claim 11, further comprising program code for:
linking a plurality of parameters, including a data importance parameter to each of said individual data;
assigning a data importance value to each of said individual data, wherein said data importance value indicates a relative value and importance of the individual data to an owner of the data set, and wherein said data importance value is utilized as one criterion to prioritize updates from an application or from changes in data content when determining a time at which to trigger a data backup, such that said data importance value correlates to a frequency at which the particular individual data is backed-up;
enabling user input of new values corresponding to the plurality of parameters for each individual data via a graphical user interface, said new values including at least the data importance value;
when said new values are not inputted, providing default values for each of said plurality of parameters;
enabling user selection of a time frequency for performing granular back-ups within the data set using a back-up timer parameter;
wherein when said time frequency is not provided, a default time frequency is established, correlated to the data importance value linked to each individual data, wherein said time frequency establishes a time period at which data assigned the particular data importance value is automatically backed-up to the data storage mechanism; and
performing said analyzing utilizing at least said data importance value to determine when to trigger the backup of the associated, individual data.

13. The computer program product of claim 12, wherein:
said plurality of parameters include:
one or more of a recovery point objective (RPO) and recovery time objective (RTO) for each class of data and application; and
one or more value changing parameters (VCPs), which indicate changes in data content over time, said VCPs including one or more of: (a) number of bytes updated; (b) number of records modified; (c) number of I/O requests; (d) number of tracks modified; (e) actual files modified; and (f) elapsed time since last backup; and
one or more threshold values corresponding to specific ones of data parameters that characterize changes in data content;
said program code for monitoring comprising code for:
monitoring changes in data content of the individual data; and
updating VCP values of the corresponding individual data based on said changes.
said program code for analyzing further comprising code for:
comparing a value of each of said one or more VCPs against a corresponding threshold value;
considering additional criteria from among: a type of data change, a source of said data changes, and established back-up triggering conditions associated with the individual data and the data set; and
said program code for dynamically triggering further comprising code for:
triggering said dynamic back-up based on at least one of said VCPs reaching its threshold value; and
automatically resetting the values of the VCPs of the individual data that is backed-up to a staring value following the backup.

14. The computer program product of claim 5, further comprising code for:
determining a type of backup to perform for the individual data by factoring a plurality of the criteria from among: (a) data importance parameter value; (b) RPO and RTO values; and (c) the crossing of preset threshold values by updates to corresponding VCP values; and
determining, based on said criteria and the extent and type of data backup required, a level of backup to perform from among: Full Volume Dumps, File Level Backups and Record Level Backups.

15. The computer program product of claim 2, wherein said data storage mechanism comprises multiple available storage locations and media, said computer program product further comprising code for:
when no user selection of a specific data storage policy is provided:
automatically assigning a selected one of the multiple storage locations and media to the individual data being backed up based on the analysis of the criteria which triggers the back-up of the individual data;
automatically selecting a first storage facility among multiple available storage facilities for frequent short term back-up of data tagged with a highest data importance value; and
subsequently enabling said data tagged with the highest data importance value to be transferred to a more permanent storage facility, wherein said transfer is completed at a second, longer frequency than the short term back-up; and
when user selection of a specific data storage policy is provided:
enabling selection of specific data storage policies assigned to the individual data within the data set, wherein said data storage policies guide a data backup of the individual data to be performed on specific storage locations and storage media;
wherein said dynamically triggering directs the specific storage location and storage media to which said data back-up is performed.

16. The computer program product of claim 1, wherein:
said program code for dynamically triggering said backup comprises code for signaling a separate data backup program to perform the backup of the specific individual data; and
when multiple backup programs are available to perform the backup, said computer program product further comprises program code for enabling a directed association between each of the individual data and specific one(s) of the multiple backup programs, such that said signaling provides a signal to the specific backup program associated with the individual data to perform the backup.

17. A data maintenance facility comprising:
a data processing system having input output devices, a processor and a memory;
at least one data storage for storing data, wherein said data is individually-modifiable (individual data); and
a data backup timing (DBT) utility providing code executing on the processor of the data processing system that enable the following functional features:
monitoring changes occurring to individual data within data set;
analyzing each of said changes against a plurality of pre-established back-up criteria that collectively determine when a data backup should occur; and
when the pre-established backup criteria for performing an backup on one of said individual data is met, dynamically triggering the back-up of that one individual data, wherein said back-up is performed independent of the other individual data whose back-up criteria are not met, wherein an automatic granular back-up of each individual data is provided, based on the current changes to that individual data in the data set.

18. The data maintenance facility of claim 16, said DBT utility further comprising program code for:
linking a plurality of parameters, including a data importance parameter to each of said individual data;
assigning a data importance value to each of said individual data, wherein said data importance value indicates a relative value and importance of the individual data to an owner of the data set, and wherein said data importance value is utilized as one criterion to prioritize backups from an application or from changes in data content when determining a time at which to trigger a data backup, such that said data importance value correlates to a frequency at which the particular individual data is backed-up;
enabling user input of new values corresponding to the plurality of parameters for each individual data via a graphical user interface, said new values including at least the data importance value;
when said new values are not inputted, providing default values for each of said plurality of parameters;
enabling user selection of a time frequency for performing granular back-ups within the data set using a back-up timer parameter;
wherein when said time frequency is not provided, a default time frequency is established, correlated to the data importance value linked to each individual data, wherein said time frequency establishes a time period at which data assigned the particular data importance value is automatically backed-up to the data storage mechanism; and
performing said analyzing utilizing at least said data importance value to determine when to trigger the backup of the associated, individual data.

19. The data maintenance facility of claim 16, wherein:
said plurality of parameters include:
one or more of a recovery point objective (RPO) and recovery time objective (RTO) for each class of data and application; and
one or more value changing parameters (VCPs), which indicate changes in data content over time, said VCPs including one or more of: (a) number of bytes backed up; (b) number of records modified; (c) number of 1/0 requests; (d) number of tracks modified; (e) actual files modified; and (f) elapsed time since last backup; and
one or more threshold values corresponding to specific ones of data parameters that characterize changes in data content;
said code for monitoring comprising code for:
monitoring changes in data content of the individual data; and
updating VCP values of the corresponding individual data based on said changes.
said code for analyzing further comprising code for:
comparing a value of each of said one or more VCPs against a corresponding threshold value;
considering additional criteria from among: a type of data change, a source of said data changes, and established back-up triggering conditions associated with the individual data and the data set; and
said code for dynamically triggering further comprising code for:
triggering said dynamic back-up based on at least one of said VCPs reaching its threshold value;
automatically resetting the values of the VCPs of the individual data that is backed-up to a staring value following the backup;
determining a type of backup to perform for the individual data by factoring a plurality of the criteria from among: (a) data importance parameter value; (b) RPO and RTO values; and (c) the crossing of preset threshold values by updates to corresponding VCP values;
determining, based on said criteria and the extent and type of data backup required, a level of backup to perform from among: Full Volume Dumps, File Level Backups and Record Level Backups;
when the utility does not include a backup program, signaling a separate data backup program to perform the backup of the specific individual data; and
when multiple backup programs are available to perform the backup, said computer program product further comprises program code for enabling a directed association between each of the individual data and specific one(s) of the multiple backup programs, such that said signaling provides a signal to the specific backup program associated with the individual data to perform the backup.

20. The computer program product of claim 2, wherein said data storage mechanism comprises multiple available storage locations and media, said computer program product further comprising code for:
when no user selection of a specific data storage policy is provided:
automatically assigning a selected one of the multiple storage locations and media to the individual data being backed up based on the analysis of the criteria which triggers the back-up of the individual data;
automatically selecting a first storage facility among multiple available storage facilities for frequent short term back-up of data tagged with a highest data importance value; and
subsequently enabling said data tagged with the highest data importance value to be transferred to a more permanent storage facility, wherein said transfer is completed at a second, longer frequency than the short term back-up;
when user selection of a specific data storage policy is provided:
enabling selection of specific data storage policies assigned to the individual data within the data set, wherein said data storage policies guide a data backup of the individual data to be performed on specific storage locations and storage media;
wherein said dynamically triggering directs the specific storage location and storage media to which said data back-up is performed.
